(19) United States
(12) Patent Application Publication
(10) Pub. No.: US 2026/0093576 A1
(43) Pub. Date: Apr. 2, 2026

(54) ERROR DETECTION AND CORRECTION

(71) Applicant: STMicroelectronics International N.V., Geneva (CH)

(72) Inventor: Fabrice ROMAIN, Rians (FR)

(73) Assignee: STMicroelectronics International N.V., Geneva (CH)

(21) Appl. No.: 19/335,606

(22) Filed: Sep. 22, 2025

(30) Foreign Application Priority Data
Sep. 27, 2024 (FR) FR2410333

(51) Int. Cl. G06F 11/10

(52) U.S. Cl. CPC G06F 11/1008

(57) ABSTRACT

A method of detecting and correcting an error on at least two bits of a binary piece of data stored in a memory includes the following successive steps: (a) modifying a value of a bit of said binary piece of data; (b) implementing a mechanism for correcting an error on a bit of said modified binary piece of data; and (c) if a fault is still detected, repeating step (a) by modifying the value of another bit of said binary piece of data.

### PRIORITY CLAIM

This application claims the priority benefit of French Application for Patent No. FR2410333, filed on September 27, 2024, the content of which is hereby incorporated by reference in its entirety to the maximum extent allowable by law.

### TECHNICAL FIELD

The present disclosure generally concerns electronic systems and devices, and the management of data by such electronic systems and devices. The present disclosure more particularly relates to the verification of data, and more specifically to the detection and correction of errors in binary data.

### BACKGROUND

Data management, during the operation of a system, or of an electronic circuit, generally requires the use of one or a plurality of memories. Operating data are, for example, written into and/or read from these memories before, or after, having been used.

It is important to be able to verify the reliability of data stored in a memory, for example, before their use or after their storage. There exist techniques enabling to detect when a bit of a binary piece of data is erroneous.

It would be desirable to be able to improve, at least partly, certain aspects of methods of detection of data errors in a memory.

There exists a need for methods for verifying data stored in a memory.

There exists a need for methods of error detection and correction in data stored in a memory.

There exists a need for methods of detection and correction of errors of at least two bits in data stored in a memory.

There exists a need for electronic devices configured to implement such error detection and correction methods.

There is a need to overcome all or part of the disadvantages of known error detection and correction methods.

### SUMMARY

An embodiment provides an error detection and correction method configured to detect and correct an error of at least two bits in data stored in a memory.

An embodiment provides an error detection and correction method using: a bit-by-bit search for a second error on a bit of this piece of data; and a method of detecting and correcting a first error on a bit of piece of data.

An embodiment provides a device configured to implement such error detection and correction methods.

An embodiment provides a method of detecting and correcting an error on at least two bits of binary piece of data stored in a memory, comprising the following successive steps: (a) modifying the value of a bit of said binary piece of data; (b) implementing a mechanism for correcting an error on a bit of said modified binary piece of data; (c) if a fault is still detected, repeating the step by modifying the value of another bit of said binary piece of data.

Another embodiment provides a device for detecting and correcting an error on at least two bits of a binary piece of data stored in a memory, configured to implement a method comprising the following successive steps: (a) modifying the value of a bit of said binary piece of data; (b) implementing a mechanism for correcting an error on a bit of said modified binary piece of data; (c) if a fault is still detected, repeating the step by modifying the value of another bit of said binary piece of data.

According to an embodiment, the method further comprises, after step (b), a step (d) during which if no fault is detected, the value of said binary piece of data is made equal to the value of said modified binary piece of data, and is considered corrected.

According to an embodiment, the method further comprises, prior to step (a), a step (e) of implementation of said mechanism for correcting an error on a bit of said binary piece of data.

According to an embodiment, the method further comprises, after step (e), a step (f) during which if no fault is detected, the value of said binary piece of data is made equal to the value of said binary piece of data obtained at step (e), and is considered corrected.

According to an embodiment, the method further comprises, after step (c), a step (g) during which if all the bit values of said binary piece of data have been modified at least once and a fault is still detected, then said binary piece of data is considered uncorrectable.

According to an embodiment, said mechanism of correction of an error on a bit uses a Hamming code.

According to an embodiment, said binary piece of data comprises bits representing an error detection and correction code and bits representing a value of said binary piece of data.

According to an embodiment, said mechanism of correction of an error on a bit comprises a step of calculation of a piece of data for comparing said detection and correction code and a code recalculated from said value of said binary piece of data.

According to an embodiment, said correction mechanism comprises circuitry for automatically calculating a corrected error detection and correction code.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 shows, very schematically and in the form of blocks, an embodiment of an electronic device configured to implement an error detection and correction method;

FIG. 2 shows a flowchart illustrating an implementation mode of an error detection and correction method;

FIG. 3 shows a block diagram illustrating an example of practical implementation of the method of FIG. 2; and

FIG. 4 shows a block diagram illustrating another example of practical implementation of the method of Figure 2.

### DETAILED DESCRIPTION

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as "front", "back", "top", "bottom", "left", "right", etc., or relative position qualifiers, such as "top", "bottom", "upper", "lower", etc., or orientation qualifiers, such as "horizontal", "vertical", etc., reference is made unless otherwise specified to the orientation of the drawings.

Unless specified otherwise, the expressions "about", "approximately", "substantially", and "in the order of" signify plus or minus 10%, preferably of plus or minus 5%.

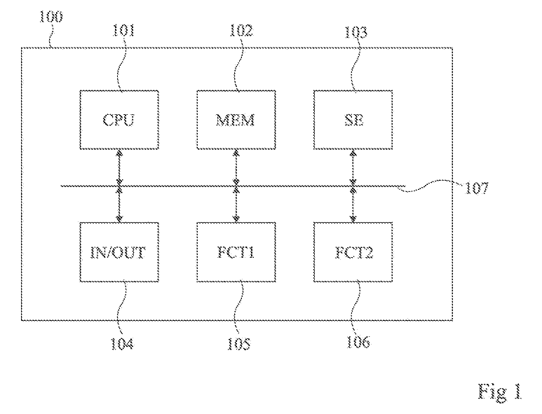

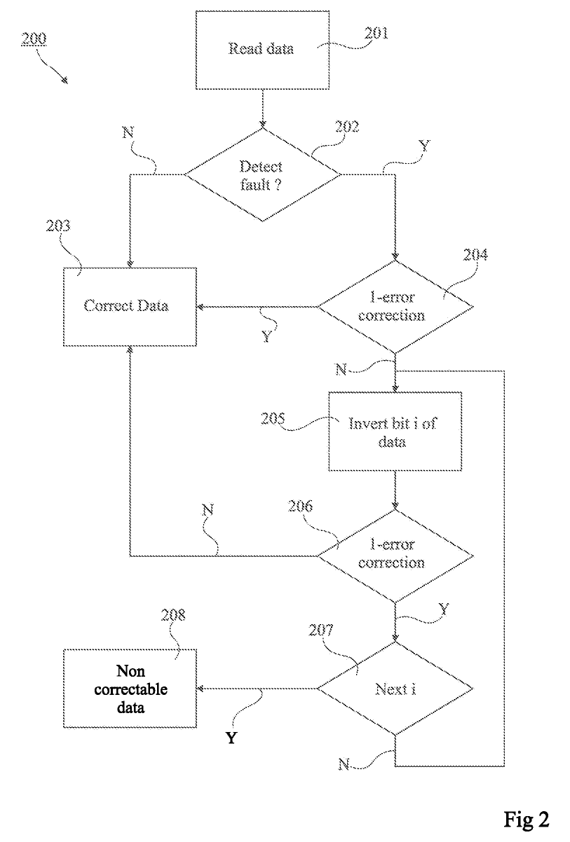

The embodiments described hereafter concern the detection and correction of errors in data stored in a memory. These embodiments more particularly relate to the detection and to the correction of an error on at least two bits in a piece of data stored in a memory. There is here called error on at least two bits an error which modifies at least two bits of a piece of data. The embodiments described hereafter search, bit by bit, which is the first error bit, until an error bit correction method is capable of correcting the second erroneous bit. Two variants of such a method and their practical example of implementation are described in relation with FIGS. 2 to 4. A device configured to implement these embodiments is described in relation with FIG. 1.

Further, the embodiments described hereabove are particularly configured for being used in any type of industrial market where an error detection and correction in data are necessary. More particularly, such an error detection method may be intended for: the automotive industry, for example in the field of automotive electrification or in the field of advanced driver assistance systems (ADAS); the industrial sector, for example in the field of green energy, in the field of infrastructure electrification, of the Internet of Things (IoT) and of smart homes, where electricity and energy consumption and data exchange are key elements; the personal electronics industry, for example in the field of mobile telephony and of the Internet of Things (IoT), as well as in the field of high-speed interfaces; and the industry of communications equipment, computers, and peripherals, for example in the field of infrastructures and data centers, and in low earth orbit (LEO) satellites.

FIG. 1 is a block diagram very schematically showing an architecture of an example of an electronic device 100 configured to implement an error detection and correction method according to an embodiment.

Electronic device 100 comprises a processor 101 (CPU) configured to implement various processing operations on data stored in memories and/or supplied by other circuits of device 100. According to an embodiment, processor 101 is configured to implement an error detection and correction method according to an embodiment.

Electronic device 100 further comprises different types of memories 102 (MEM), including, for example, a non-volatile memory, a volatile memory, and/or a read-only memory. Each memory 102 is configured to store different types of data. According to an embodiment, the detection and correction methods described in relation with FIGS. 2 to 4 are particularly configured to process data stored in non-volatile memories, such as flash memories, phase-change memories (PCM), magnetic RAMs, resistive RAMs, etc. According to an embodiment, one or a plurality of memories 102 comprise a circuit dedicated to the implementation of error detection and correction methods.

Electronic device 100 further comprises, for example, a secure element 103 (SE) configured to process sensitive and/or secret data. Secure element 103 may comprise its own processor(s), its own memory or memories, etc. According to an embodiment, secure element 103 is configured to implement an error detection and correction method according to an embodiment, and, more particularly, according to an example, secure element 103 comprises a memory comprising a circuit dedicated to the implementation of error detection and correction methods.

Electronic device 100 may further comprise interface circuits 104 (IN/OUT) configured to send and/or to receive data originating from outside device 100, such as originating from an external memory. Interface circuits 104 may further be configured to implement a data display, for example, a display screen. According to an example, the interface circuits are configured to implement an error detection and correction method according to an embodiment.

Electronic device 100 further comprises various circuits 105 (FCT1) and 106 (FCT2) configured to perform different functions. As an example, circuits 105 and 106 may comprise measurement circuits, data conversion circuits, etc. According to an embodiment, circuits 105 and 106 may comprise a circuit configured to implement an error detection and correction method according to an embodiment.

Electronic device 100 further comprises one or a plurality of data buses 107 configured to transfer data between its various components.

FIG. 2 is a flow diagram illustrating an embodiment of a method 200 for detecting and correcting an error on at least two bits of binary piece of data stored in a memory.

What is referred to here as a binary piece of data Data200 means a piece of data programmed over a plurality of data bits, for example over N data bits, where N is a positive integer. Each bit of the binary piece of data is noted Data200Bit[i], i being an integer between 0 and N-1 representing the place of the bit in binary piece of data Data200.

Further, according to an example, binary piece of data Data200 is formed of a first group of bits representing the value of binary piece of data Data200, and of a second group of bits representing an error detection and correction code (ECC) of binary piece of data Data200. According to an example, the first group of bits comprises P bits, P being a positive integer smaller than or equal to N, and the second group of bits comprises Q bits, Q being a positive integer smaller than N. According to an example, the sum of integers P and Q is equal to integer N.

Further, what is referred to here as a single-bit error means an error of a binary piece of data in which only one data bit of the binary piece of data is erroneous. There exist mechanisms for finding and correcting such errors which use the error detection and correction code of the binary piece of data to directly correct this piece of data. Such mechanisms are described hereafter.

Similarly, what is referred to here as a two-bit error means an error of a binary piece of data in which at least two data bits of the binary piece of data are erroneous.

The aim of method 200 is to verify the conformity of binary piece of data stored in a memory, and more particularly to detect a fault in binary piece of data and to correct this fault as much as possible. What is referred to here as a fault means an error on a binary piece of data, for which the number of bits that it affects in the binary piece of data is not determined. A fault is, for example, detected by using the code error detection and correction of a binary piece of data. Method 200 is more particularly configured to detect and correct single-bit and two-bit errors in a binary piece of data. According to a variant, method 200 may be used in a method of detecting and correcting errors on at least three bits of a binary piece of data.

In an initial step 201 (Read data), binary piece of data Data200 is read from a memory.

At a step 202 (Detect fault?), successive to step 201, a fault detection operation is applied to binary piece of data Data100. Such an operation uses, for example, the error detection and correction code to detect a fault. Implementations of a fault detection operation are within the abilities of those skilled in the art, and are not described in detail herein. If no fault is detected (output N of step 202), the next step is step 203 (Correct Data), otherwise (output Y of step 202) the next step is a step 204 (1-error correction).

At step 203, successive to step 202, no fault has been detected in binary piece of data Data200, whereby binary piece of data Data200 can be considered as correct.

At step 204, a fault has been detected in binary piece of data Data200. As previously mentioned, the number of erroneous bits in binary piece of data Data200 is not determined. A correction attempt operation on a 1-bit error is applied to binary piece of data Data200. According to an example, such an operation may be based on the calculation of a Hamming code, also known as a Hamming correction code. Implementations of 1-bit error correction operations are within the abilities of those skilled in the art, and are not described in detail herein.

If the 1-bit correction attempt succeeds (output Y of step 204), the piece of data is now corrected and the next step is step 203, otherwise (output N of step 204) the next step is step 205.

According to a variant, steps 202 and 204 may be combined. According to another variant, step 202 may be omitted.

At step 203, successive to step 204, binary piece of data Data200 has been corrected at step 204, binary piece of data Data200 is made equal to the corrected binary piece of data Data200, and binary piece of data Data200 can thus be considered as correctly corrected and thus as correct.

At a step 205 (Invert bit i of data), successive to step 204, a fault is still detected in binary piece of data Data200. The modified binary piece of data obtained at step 204 is no longer considered, and the original binary piece of data Data200 is used.

At step 205, the value of a bit Data200Bit[i] of rank i of binary piece of data Data200 is modified to obtain a modified binary piece of data Data200Modif[i]. According to an example, for the first implementation of step 205, integer i is equal to zero.

At a step 206 (1-error correction), successive to step 205, an operation of attempt to correct a 1-bit error is applied to the modified binary piece of data Data200Modif[i]. This 1-bit error correction operation is of the type of that of step 204.

Further, at step 206, after the correction attempt operation, a fault detection operation, of the type of the operation of step 202, is implemented concerning the corrected modified binary piece of data Data200Modif[i]. If no fault is detected (output N of step 206), this indicates that the correction attempt has succeeded and the next step is step 203, otherwise (output Y of step 206) the next step is a step 207 (Next i).

At step 203, successive to step 206, no fault has been detected in the modified binary piece of data Data200Modif[i] corrected at step 206, binary piece of data Data200 is made equal to the corrected modified binary piece of data Data200Modif[i], and binary piece of data Data200 can thus be considered as correctly corrected and thus as correct.

At step 207, a fault is still detected in binary piece of data Data200. This means that the bit modified at step 205 had a correct initial value. It must thus be attempted to modify the value of another bit of binary piece of data Data200, for which purpose a new integer i is selected, for example by incrementing the previously-selected value of i by one unit.

At step 207, it is also verified that all the values of the integer have been tested. For example, if integer i is incremented at step 207, then it is verified that integer i does not exceed number N-1, which is the rank of the last bit of binary piece of data Data200. If all the values of integer i have been tested (output Y of step 207), the next step is a step 208, otherwise (output N of step 207) the next step is step 205.

At step 205, successive to step 207, the value of a bit Data200Bit[i] of rank i, i having been modified at step 207, of binary piece of data Data200 is modified to obtain a modified binary piece of data Data200Modif[i]. The correction operation of step 206 is then implemented.

At step 208, all the bits of binary piece of data Data200 have been modified at least once, and the correction operation carried out at step 206 has not been able to provide a correct corrected binary piece of data. This means that the fault detected in the binary piece of data at step 202 concerns more data bits. Binary piece of data Data200 is thus considered as uncorrectable by the use of method 200 alone.

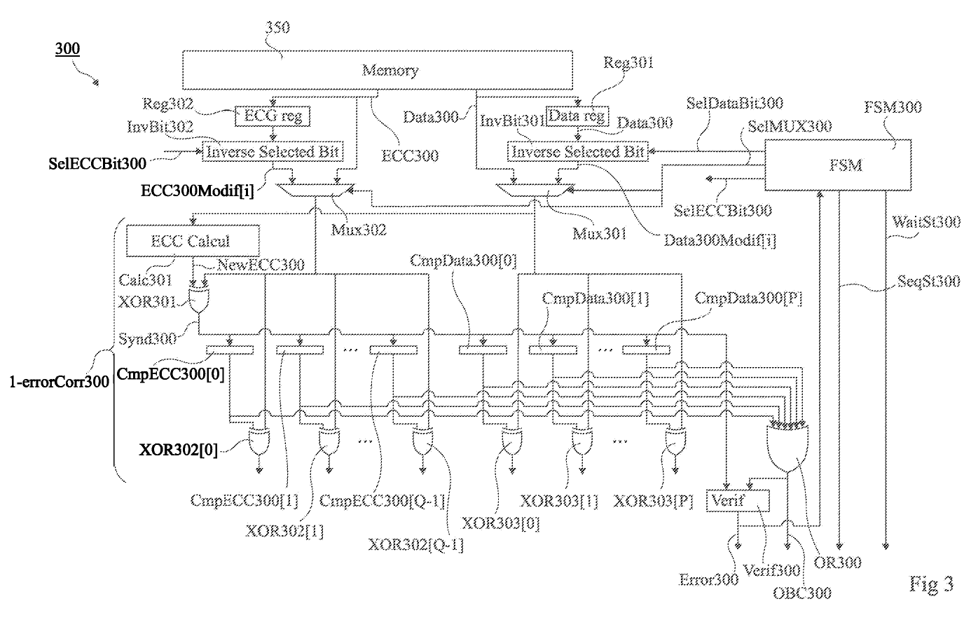

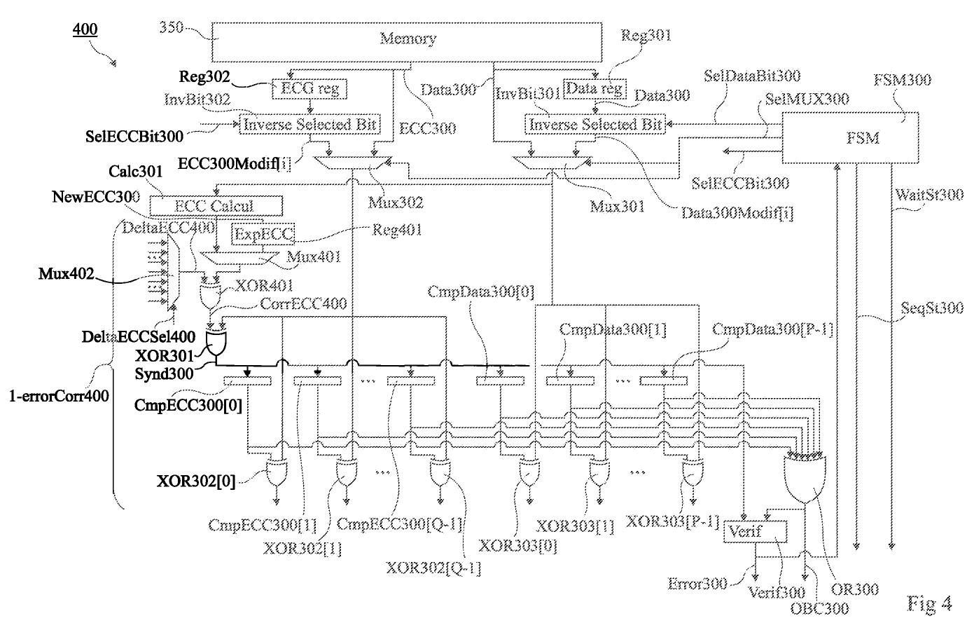

An advantage of error detection and correction method 200 is that it enables to reliably correct a two-bit error in a binary piece of data. Other advantages are described in relation with FIGS. 3 and 4.

Further, it should be noted that a method of the type of method 200 can be used in a method of detecting and correcting an error on at least three bits.

FIG. 3 shows, schematically and partially in the form of blocks, a practical example of a device 300 for implementing the method 200 described in relation with FIG. 2.

According to an example, device 300 is configured to receive a piece of data Data300 and its error detection and correction code ECC300, both stored in a memory 350 (Memory). According to an example, in memory 350, binary piece of data Data300 and its error detection and correction code ECC300 are stored in the form of two parts of the same data word.

According to an example, device 300 comprises a first register Reg301 (Data reg) configured to store data Data300, and a second register Reg302 (ECC reg) configured to store code ECC300.

According to an example, device 300 further comprises two circuits InvBit301 (Inverse Selected Bit) and InvBit302 (Inverse Selected Bit) configured to invert a bit of a data word. Circuit InvBit301 is configured to invert a bit of the piece of data Data300 stored in register Reg301, the rank of the bit to be inverted being selected by a control signal SelDataBit300. Circuit InvBit302 is configured to invert a bit of the code ECC300 stored in register Reg302, the rank of the bit to be inverted being selected by a control signal SelECCBit300.

According to an example, device 300 further comprises two multiplexers Mux301 and Mux302, each comprising two input terminals, a control terminal, and an output terminal. According to an example, multiplexer Mux301 receives, on a first input terminal, binary piece of data Data300, and, on a second input terminal, a piece of data supplied by circuit InvBit301. A control terminal of multiplexer Mux301 receives a control signal SelMux300. According to an example, multiplexer Mux302 receives, on a first input terminal, code ECC300, and, on a second input terminal, a piece of data supplied by circuit InvBit302. A control terminal of multiplexer Mux302 receives a control signal SelMux300. Multiplexers Mux301 and Mux302 are used to define whether a 1-bit error correction operation is implemented on piece of data Data300 and code ECC300, or on a modified version of piece of data Data300 and of code ECC300.

According to an example, device 300 further comprises a control circuit FSM300 (FSM). Circuit FSM300 is, for example, configured to supply control signals SelDataBit 300, SelECCBit300, and SelMux300. Circuit FSM300 may, further, be configured to supply a signal WaitSt300 indicating a waiting state of device 300, and a signal SeqSt300 indicating that a 2-bit error search is in progress. According to an example, control circuit FSM300 is a state machine.

According to an example, device 300 further comprises a stage 1-errorCorr300 for detecting and correcting a 1-bit error.

According to an example, stage 1-errorCorr300 comprises a circuit Calc301 configured to calculate an error detection and correction code NewECC300 from the piece of data supplied at the output of multiplexer Mux301. As a reminder, this piece of data is either equal to binary piece of data Data300, or equal to a modified version of binary piece of data Data300 in which one bit has been inverted.

According to an example, stage 1-errorCorr300 further comprises an EXCLUSIVE OR (XOR) logic gate XOR301 used to compare code ECC300 and code NewECC300. In other words, gate XOR301 comprises two input terminals, one receiving code ECC300 and the other code NewECC300. Gate XOR301 outputs a comparison piece of data Synd300, also known as syndrome Synd300, which is the result of the application of the EXCLUSIVE OR logic gate bit by bit of the two inputs.

According to an example, stage 1-errorCorr300 further comprises Q comparators CmpECC300[0] to CmpECC300[Q-1] and Q XOR logic gates XOR302[0] to XOR302[Q-1]. Each comparator CmpECC300[0], ..., CmpECC300[Q-1] compares data Synd300 with a constant reference value. The result of this comparison is then used by the gate XOR302[0], ..., XOR302[Q-1], at the corresponding rank bit of the piece of data supplied at the output of multiplexer Mux302, in order to possibly invert and thus correct the corresponding bit of the piece of data. As a reminder, this piece of data is either equal to code ECC300, or to a modified version of code ECC300 in which one bit has been inverted. In other words, each gate XOR302[0], ..., XOR302[Q-1] comprises two input terminals, one of which receives a bit of the output piece of data of multiplexer Mux302, the other receiving a bit resulting from the comparison between piece of data Synd300 and the constant reference value.

According to an example, stage 1-errorCorr300 further comprises P comparators CmpData300[0] to CmpData300[P-1] and P XOR logic gates XOR303[0] to XOR303[P-1]. Each comparator CmpData300[0], ..., CmpData300[P-1] compares piece of data Synd300 with a constant reference value. The result of this comparison is then used by gate XOR303[0], ..., XOR303[P-1], together with the bit of same rank of the piece of data output by multiplexer Mux301, in order to possibly invert and thus correct the corresponding bit of the piece of data. As a reminder, this piece of data is either equal to binary piece of data Data300, or to a modified version of piece of data Data300 in which a bit has been inverted. In other words, each gate XOR303[0], ..., XOR303[P-1] comprises two input terminals, one of which receives the output piece of data of multiplexer Mux301, and the other a bit resulting from the comparison between piece of data Synd300 and the constant reference value.

According to an example, stage 1-errorCorr300 further comprises an OR-type logic gate OR300 comprising P+Q inputs, each coupled to one of comparators CmpECC300[0], ..., CmpECC300[Q-1], CmpData300[0], ..., CmpData300[P-1]. Gate OR300 further comprises an output terminal supplying a signal OBC300 enabling to verify whether a data bit has been inverted and thus corrected.

According to an example, stage 1-errorCorr300 further comprises a verification circuit Verif300 which takes as inputs signal OBC300 and the Q-bit output signal of gate XOR301. If signal OBC300 is equal to zero and the output signal of the XOR gate is different from zero, then the data output by multiplexers Mux301 and Mux302 are erroneous data.

The operation of device 300 is the following.

When steps 202 and 204 are implemented, multiplexers Mux301 and Mux302 directly supply the piece of data received from memory 350, that is, piece of data Data300 and code ECC300. Calculation circuit Calc301 calculates code NewECC300 from piece of data Data300, and gate XOR301 uses it to obtain comparison piece of data Synd300. This comparison piece of data Synd300 only comprises bits at 1 at the ranks where code ECC300 and code NewECC300 are different. Gates XOR302[0] to XOR302[Q-1] and XOR303[0] to XOR303[P-1] are then used to modify the value of a bit of code ECC300 or of piece of data Data300. The bits output from XOR302[0] to XOR302[Q-1] and XOR303[0] to XOR303[P-1] enable to form a code and a corrected piece of data.

When steps 205 to 207 are implemented, multiplexers Mux301 and Mux302 supply a modified one-bit version of code ECC300 or of piece of data Data300. Calculation circuit Calc301 calculates code NewECC300 from piece of data Data300, or its modified version if applicable, and gate XOR301 uses it to obtain comparison piece of data Synd300. This comparison piece of data Synd300 only comprises bits at 1 at the ranks where code ECC300, or its modified version if applicable, and code NewECC300 are different. Gates XOR302[0] to XOR302[Q-1] and XOR303[0] to XOR303[P-1] are then used to modify the value of a bit of code ECC300 or of piece of data Data300. The bits output from gates XOR302[0] to XOR302[Q-1] and XOR303[0] to XOR303[P-1] enable to form a code and a corrected piece of data.

An advantage of such an implementation is that it limits the number of additional bits stored in memory, the number of added logic gates.

FIG. 4 shows, schematically and partially in the form of blocks, another practical example of a device 400 for implementing the method 200 described in relation with FIG. 2.

Device 400 is very similar to the device 300 described in relation with FIG. 4. The elements common to devices 300 and 400 are not here described again in detail. Only the differences between devices 300 and 400 are highlighted.

Like device 300, device 400 comprises: registers Reg301 (Data reg) and Reg302 (ECC reg); circuits InvBit301 (Inverse Selected Bit) and InvData302 (Inverse Selected Bit); multiplexers Mux301 and Mux 302; and control circuit FSM300 (FSM).

According to an example, the difference between devices 300 and 400 lies in the 1-bit error detection and correction stage. Device 400 comprises a 1-bit error detection and correction stage 1-errorCorr400, which further comprises circuitry for automatically calculating a corrected error detection and correction code.

According to an example, like stage 1-errorCorr300, stage 1-errorCorr400 further comprises: calculation circuit Calc301; the P+Q comparators CmpECC300[0] to CmpECC300[Q-1] and CmpData300[0] to CmpData300[P-1]; the P+Q XOR logic gates XOR302[0] to XOR303[Q-1], and XOR303[0] to XOR303[P-1]; OR-type gate OR300; and verification circuit Verif300.

According to an example, the automatic calculation circuitry comprises a register Reg401, two multiplexers Mux401 and Mux402, and a logic gate XOR401. Register Reg401 is configured to store the expected value of code ECC300, this value being supplied by calculation circuit Calc301. Multiplexer Mux401 comprises two input terminals and one output terminal. A first input terminal is configured to receive code NewECC300, and the second input is configured to receive the piece of data stored in register Reg401. The output of multiplexer Mux401 is coupled, preferably connected, to an input of gate XOR401.

The second multiplexer Mux402 is configured to receive at its input different comparison data of the type of comparison piece of data Synd300, each of these data representing the comparison piece of data obtained when a bit of code ECC300 is modified or when a bit of piece of data Data300 is modified. The correct value is selected by a signal DeltaECCSEl400 supplied by control circuit FSM300. This value is selected according to the bit which is modified by circuits InvBit301 or InvBit302.

This embodiment enables to do without a step of calculation of comparison data Synd300.

Various embodiments and variants have been described. Those skilled in the art will understand that certain features of these various embodiments and variants may be combined, and other variants will occur to those skilled in the art.

Finally, the practical implementation of the described embodiments and variants is within the abilities of those skilled in the art based on the functional indications given hereabove.

1. A method of detecting and correcting an error on at least two bits of a binary piece of data stored in a memory, comprising the following successive steps:
(a) modifying a value of a bit of said binary piece of data to produce a modified binary piece of data;
(b) implementing a mechanism for correcting an error on a bit of said modified binary piece of data;
(c) when an error is still detected, repeating step (a) by modifying the value of another bit of said binary piece of data and then performing step (b).

2. The method according to claim 1, further comprising, after step (b) and where no fault is detected after implementing the mechanism for correcting, d) making the value of said binary piece of data equal to the value of said modified binary piece of data, and considering the error corrected.

3. The method according to claim 1, further comprising, prior to step (a), (e) implementing said mechanism for correcting an error on a bit of said binary piece of data.

4. The method according to claim 3, further comprising, after step (e), and where no fault is detected after implementing the mechanism for correcting, f) making the value of said binary piece of data equal to the value of said binary piece of data obtained at step (e), and considering the error corrected.

5. The method according to claim 1, further comprising, after step (c), and where all the bit values of said binary piece of data have been modified at least once and a fault is still detected, g) considering said binary piece of data to be uncorrectable.

6. The method according to claim 1, wherein said mechanism of correction of an error on a bit uses a Hamming code.

7. The method according to claim 1, wherein said binary piece of data comprises bits representing an error detection and correction code and bits representing a value of said binary piece of data.

8. The method according to claim 7, wherein said mechanism of correction of an error on a bit comprises calculation of a piece of data of comparison of said detection and correction code and a code recalculated from said value of said binary piece of data.

9. The method according to claim 7, wherein said mechanism of correction comprises circuitry for automatically calculating a corrected error detection and correction code.

10. A device for detecting and correcting an error on at least two bits of a binary piece of data stored in a memory, configured to implement the method of claim 1.
